(19) United States
(12) Patent Application Publication
(10) Pub. No.: US 2006/0155481 A1
(43) Pub. Date: Jul. 13, 2006

(54) System and method for reusing project planning data

(76) Inventors: Diamantis Gikas, Nurnberg (DE); Ronald Lange, Furth (DE); Ralf Leins, Ispringen (DE); Klaus Meusser, Furth (DE); Jurgen Schmoll, Markt Berolzheim (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/313,124

(22) Filed: Dec. 20, 2005

(30) Foreign Application Priority Data
Dec. 21, 2004 (EP) 04030319.0

(51) Int. Cl. G06F 19/00; G06G 7/48; G06G 7/58

(52) U.S. Cl. 702/19; 703/11

(57) ABSTRACT

The invention relates to a system and a method for managing and/or providing partial solutions consisting of elements. With the aid of the system and method, existing partial solutions can be reused and updated. Here at least one partial solution is created, especially by a user, with the at least one partial solution serving as a template for creating a copy. The created partial solution is saved in a library and a copy of a saved partial solution (2l..2n) is created. The at least one copy of the partial solution thus serves for use in creating a solution, in particular an automation solution.

### CROSS REFERENCE TO RELATED APPLICATIONS

This application claims priority to the European Application No. 04030319.0, filed Dec. 21, 2004 which is incorporated by reference herein in its entirety.

### FIELD OF INVENTION

The invention relates to a system and method for managing and/or providing partial solutions consisting of elements.

### BACKGROUND OF INVENTION

When the creating an automation solution, it is advantageous for the project planner to be able to reuse existing partial solutions which have been developed in another project. For this purpose, existing partial solutions can be saved in a library for instance, which can then be accessed within the scope of the engineering. Within the scope of a new project, these partial solutions are then accordingly reused and in some circumstances adjusted and/or modified. The partial solutions can thus comprise a number of elements, technological objects for instance, which represent parts of an automated plant. Typical technological objects in such cases are boilers, valves or terminals.

### SUMMARY OF INVENTION

On the basis of the engineering systems used nowadays, it is presently not possible to update existing partial solutions, used as a copy from another project in a current project, such that updated elements are transferred into the partial solution.

An object of the present invention is to specify a system and a method, with the aid of which existing partial solutions can be reused and updated.

The object is achieved by a system for managing and/or providing partial solutions consisting of elements, in particular solutions comprising a number of technological objects for an automation system, with first means for creation of at least one partial solution, especially by a user of the system, with the at least one partial solution being provided as a template for creating a copy, having a library for storing at least one created partial solution and having second means for creating at least one copy of a saved partial solution, with the at least one copy of the partial solution being provided for use in creating a solution, in particular an automation solution.

The object is further achieved by a method for managing and/or providing partial solutions consisting of elements, in particular solutions comprising a number of technological objects for an automation system, in which at least one partial solution is created, especially by a user, with the at least one partial solution serving as a template for creating a copy, with at least the created partial solution being saved in a library and at least one copy of a saved partial solution being created, with the at least one copy of the partial solution serving to be used in the creation of a solution, in particular an automation solution.

The invention is based on the knowledge that an already created solution should be reusable within the scope of a new engineering project and for this purpose should be available as a library element. A copy of the already existing solution is thus created and the copy can subsequently be modified within the scope of the new project. The copy of the partial solution thus has all the code elements necessary for its implementation within the scope of the new project and the copy is able to adjust itself during use within the scope of the new project (block numbers for instance).

The copy of the partial solution thus consists of individual technological elements. The technological elements are likewise components of the library and the copy of the partial solution can likewise be updated if the technological elements are changed. The partial solution can be updated automatically or by a user, who selects the elements which are to be updated.

For this purpose, means are available within the scope of the system for defining modifiable and/or adaptable elements and/or parameters of a partial solution. A user or an author of a partial solution can indicate the parts of a partial solution which have to be adapted if the partial solution is used. Furthermore, the copy of the partial solution, in other words the instance, has a reference to its source, so that an update of the corresponding copy of the partial solution is possible if the original partial solution is changed. This is undertaken for instance, after definition by a user, only in specific elements previously characterized as modifiable or adaptable.

A further advantageous embodiment of the invention is characterized in that an element is designed as a root element of the partial solution. This allows for the creation of a tree-like structure, in which technological objects serve for instance as root elements. During the creation of a copy of the partial solution, besides the program code relevant for the implementation, only such code elements belonging to the root element or to one of the corresponding subfolders are copied.

A further advantageous embodiment of the invention is characterized in that a bidirectional connection is provided between the partial solution and the one or more copies of the partial solution in each instance. Direct access to the original partial solution serving as a basis for the copies is thus possible. The copies created can be updated by means of this bidirectional connection, which is configured as a link.

A further advantageous embodiment of the invention is characterized by the elements of the partial solution and the elements of the copies of the partial solution featuring time stamps for documenting changes activated by a user. The entire copy of the partial solution does not therefore have to be updated if an element in the library or a technological object in the library is changed for example. A time -based comparison can be carried out in this instance which checks whether the element in the partial solution, which has served as a basis, or the element in the copy of the partial solution is more up -to-date. The elements in the copy of the partial solution are only automatically updated if the elements in the basis, which were available for the copies, were updated and the corresponding elements in the copy were not changed. If on the other hand both cases apply, the elements in the basis and the copy can either be merged automatically together (adopt changes in basis and copy) or the user can be asked which of the changes (basis or copy) he wishes to adopt. Alternatively, with the aid of the present system the entire copy of the partial solution can also be updated if the user so wishes. Here again not all existing copies have to be updated. The user is able to select which of the copies of the partial solution formed are to be updated on the basis of the new partial solution.

### BRIEF DESCRIPTION OF THE DRAWINGS

The invention is described and explained below infer detail with reference to the exemplary embodiments shown in the figures, in which:

FIG. 1 shows a schematic representation of the system for managing and providing partial solutions,

FIG. 2 shows a schematic representation of a model for partial solution.

### DETAILED DESCRIPTION OF INVENTION

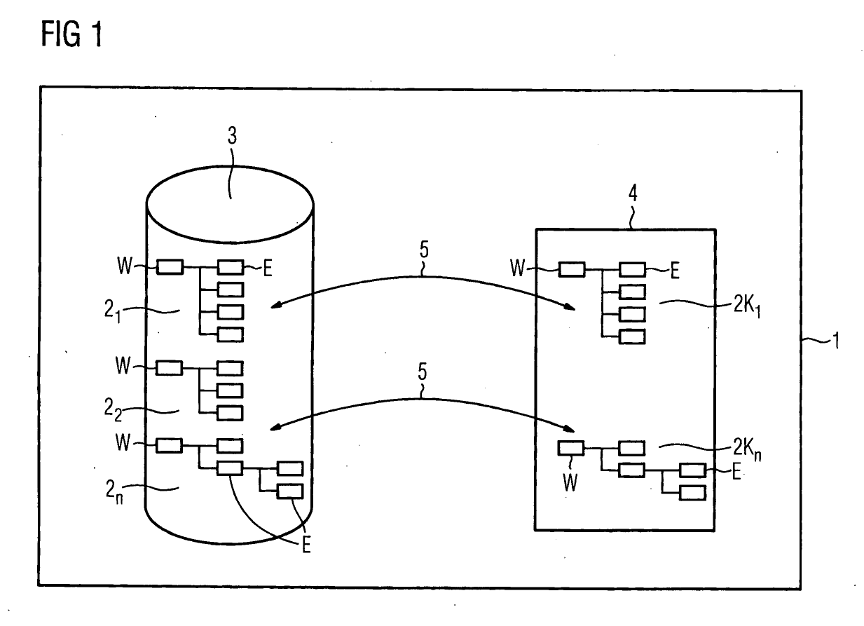

FIG. 1 shows a system 1 for managing and providing partial solutions 2ₗ..2ₙ. Here the partial solutions consist of elements E. A partial solution comprises an element as a root element W in each instance. The partial solutions are saved in a library 3 within the scope of the system. Within the scope of the system, copies 2Kₗ.2Kₙ are created from the existing partial solutions. The copies of the partial solutions can be used for an automation system within the scope of a solution 4. Bidirectional connections 5 designed in the form of a link exist between the partial solutions and their copies.

The linking allows the copies of the partial solution to be updated if a partial solution or elements of a partial solution saved in the library were changed. The updating can thus be controlled by the user of the system 1. The copies of the partial solution are virtual instances of the solutions saved in the library. An instance includes the necessary amount of information which is important for the implementation.

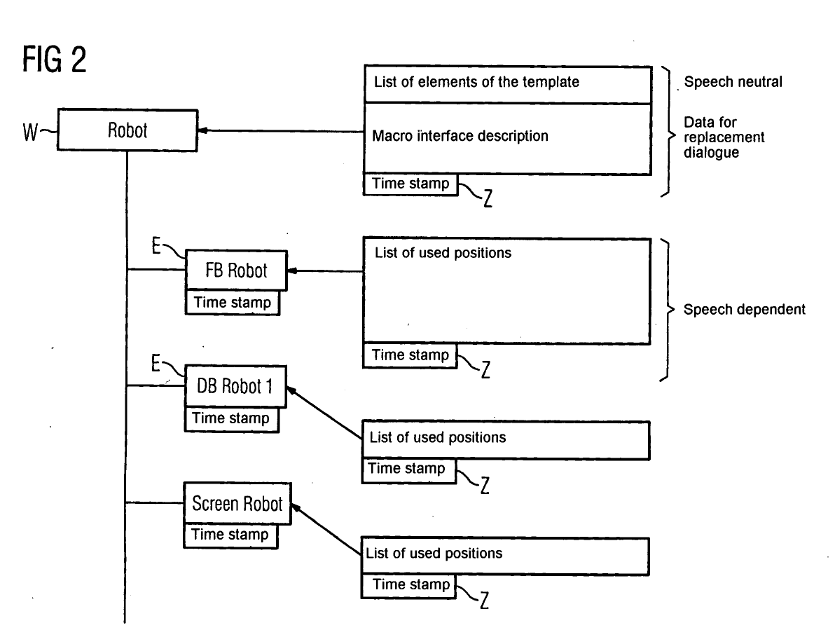

FIG. 2 shows a basic model for a partial solution designed as a template. In this example, ‘robot’ is the root element of the partial solution which was created, in which a technological file was used. The root element contains a list of all the elements found in this partial solution, for example “FB robot”, “DB robot 1” und “Screen robot”. The root element further contains a list of parameters (Macro Interface Description) and their names as well as the basic value, with which the parameter is occupied and a commentary. This information is needed within the scope of the dialogue, which shows if the copy of the partial solution is used. This description or information is independent of language used, i.e. it is not dependent on the types, elements or technological objects which are integrated in the partial solution. For this reason this interface information or description and the dialog of the partial solution can be displayed or processed with a generally-available software component.

The elements of the partial solution, i.e. “FB robot”, “DB robot 1” und “Screen robot” have a list of parameters of the template or of the partial solution used by the respective element and they also possess the information as to where they are used. This list is dependent on the speech of the respective element, as the information regarding where a parameter of the copy of the partial solution is used can generally not be described.

The partial solution or its copies is used within the new project. The structure of the copy or the instance of the partial solution is thus identical to the structure of the basic partial solution saved in the library. The individual elements have time stamps Z which show when the relevant element was last processed or updated. The copies of the partial solution or the instances can be updated in a user -defined or a general fashion on the basis of these time stamps. An element is only replaced if its time stamp is older than that of the corresponding element of the basic partial solution in the library. If the time stamps of the copy are older, they are automatically updated. If however both time stamps have been changed compared to the “copy or instancing process” (thus changes were made on both sides), either the changes of basics and copies are mixed together or the user is asked which changes he wishes to adopt. This allows a partial solution to be reused and updated in a simple manner.

1-20. (canceled)

21. A system for managing or providing a solution, the solution including partial solutions having solution elements, the system comprising:
a first engineering unit for creating at least a partial solution, the partial solution serving as a model for creating a copy of the at least one partial solution;
a library for storing at least the created partial solution; and
a second engineering unit for creating at least one copy of a stored partial solution, wherein a solution is created based on the at least one copy of the stored partial solution.

22. The system according to claim 21, wherein the solution is an automation algorithm and the solution elements comprise a number of technological objects used in an automation system.

23. The system according to claim 21, further comprising a third engineering unit for defining an element chosen from the group consisting of a modifiable element, an adaptable element and an adaptable parameter, the element related to the partial solution.

24. The system according to claim 23, wherein the element is a root element of the partial solution.

25. The system according to claim 21, further comprising a bi-directional connection for connecting the partial solution and the at least one copy.

26. The System according to claim 21, wherein the partial solution and the at least one copy each include a time stamp for documenting amendments executed by a user.

27. The system according to claim 26, further comprising a fourth engineering unit for updating the at least one copy if the corresponding partial solution is amended or replaced.

28. The system according to claim 27, wherein the fourth engineering unit is configured to update the at least one copy after comparing the time stamp of the partial solution to the time stamp of the at least one copy.

29. The system according to claim 28, wherein the fourth engineering unit updates the at least one copy if the time stamp of the at least one copy is older than the time stamp of the partial solution.

30. The system according to claim 27, wherein the fourth engineering unit is configured to execute a user query if both the time stamp of the at least one copy and the time stamp of the partial solution are younger than a date corresponding to a copy process related to the partial solution, the user query requesting information about whether to update the at least one copy or the partial solution or both.

31. A method for managing or providing a solution, the solution including partial solutions having solution elements, the method comprising:
creating at least one partial solution;
using the at least one partial solution as a template for creating a copy of the at least one partial solution;
storing the created partial solution in a library;
creating at least one copy of the stored partial solution; and
creating a solution based on the at least one copy of the stored partial solution.

32. The method according to claim 31, further comprising defining an element chosen from the group consisting of a modifiable element, an adaptable element and an adaptable parameter, the element related to the partial solution.

33. The method according to claim 32, wherein the element is a root element of the partial solution.

34. The method according to claim 31, further comprising bi-directionally connecting the partial solution and the at least one copy.

35. The method according to claim 31, further comprising documenting user amendments to the partial solution or the at least one copy by a time stamp assigned to the partial solution respectively the at least one copy.

36. The method according to claim 35, further comprising updating the at least one copy if the corresponding partial solution is amended or replaced by a user.

37. The method according to claim 36, wherein the at least one copy is updated after comparing the time stamp of the partial solution to the time stamp of the at least one copy.

38. The method according to claim 37, wherein the at least one copy is updated if the time stamp of the at least one copy is older than the time stamp of the partial solution.

39. The method according to claim 37, further comprising asking a user about an update to be carried out if both the time stamp of the at least one copy and the time stamp of the partial solution are younger than a date corresponding to a copy process related to the partial solution.

40. The method according to claim 31, wherein the at least one copy is created by an engineering system for use in an automation system.
